(19) United States
(12) Patent Application Publication
(10) Pub. No.: US 2009/0251649 A1
(43) Pub. Date: Oct. 8, 2009

(54) Liquid crystal display

(76) Inventors: Yeon-Cu Kim, Yongin-si (KR); Young-Woon Kho, Cheonan-si (KR); Hye-Rhee Han, Suwon-si (KR); Yu-Jun Kim, Incheon-si (KR)

Correspondence Address: Haynes and Boone, LLP;IP Section, 2323 Victory Avenue, SUITE 700, Dallas, TX, 75219, US

(21) Appl. No.: 12/384,746

(22) Filed: Apr. 7, 2009

(30) Foreign Application Priority Data
Apr. 8, 2008 (KR) 10-2008-0032590

(51) Int. Cl. G02F 1/1339; H01J 9/20; G02F 1/1333; C09K 19/52

(52) U.S. Cl. 349/110; 349/153; 445/25; 428/1.52

(57) ABSTRACT

A liquid crystal display that is less vulnerable to signal line corrosion due to infiltration of moisture is presented. The display includes: a first display panel and a second display panel facing each other; a sealant disposed between the first display panel and the second display panel to define a sealant region and couple the first display panel and the second display panel to each other; a blocking member disposed between the first display panel and the second display panel and neighboring the sealant; and a liquid crystal interposed between the first display panel and the second display panel, and disposed in the sealant region. The blocking member includes silicone formed from a silane derivative having at least one butyrate.

### CROSS-REFERENCE TO RELATED APPLICATION

This application claims priority to and the benefit of Korean Patent Application No. 10-2008-0032590 filed in the Korean Intellectual Property Office on Apr. 8, 2008, the entire content of which are incorporated herein by reference.

### BACKGROUND OF THE INVENTION

(a) Field of the Invention

The present invention relates to a liquid crystal display.

(b) Description of the Related Art

Liquid crystal displays (LCDs) are one of the most widely used types of flat panel displays. A liquid crystal display includes two display panels on which field generating electrodes are formed and a liquid crystal layer that is interposed between the panels. In the liquid crystal display, a voltage is applied to the field generating electrodes to generate an electric field, and the alignment of the liquid crystal molecules in the liquid crystal layer is determined by the electric field. Accordingly, the transmittance of light passing through the liquid crystal layer is controlled.

Among liquid crystal displays, widely used liquid crystal displays include field generating electrodes formed at two display panels. Particularly, a general structure of the widely used liquid crystal displays includes one display panel having a plurality of pixel electrodes disposed in a matrix form and the other panel having a common electrode covering substantially the whole surface.

In a liquid crystal display, each pixel electrode separately receives a voltage to display images. A thin film transistor (TFT) as a three terminal element is connected to each pixel electrode for switching the voltage applied to the pixel electrode, and a plurality of gate lines transmitting signals to control the thin film transistor and a plurality of data lines transmitting the voltage that is applied to the pixel electrode are provided. The thin film transistor has the function of a switching element for transmitting or blocking the data signals applied through each data line to the pixel electrode according to a scanning signal applied through the gate line.

On the other hand, quid crystal display is vulnerable to moisture. Particularly, a pad portion of the gate lines and a pad portion of the data lines that extend outside the sealant region are exposed to moisture in the environment, thereby being easily corroded. In this case, the gate line and the data line may be shorted, or deterioration of the connection with the external circuit may be generated such that deterioration of the liquid crystal display may occur.

The above information disclosed in this Background section is only for enhancement of understanding of the background of the invention and therefore it may contain information that does not form the prior art that is already known in this country to a person of ordinary skill in the art.

### SUMMARY OF THE INVENTION

Accordingly, the present invention prevents the corrosion of the gate line and the data line to improve the deterioration of the liquid crystal display.

A liquid crystal display according to an exemplary embodiment of the present invention includes a liquid crystal display including a first display panel and a second display panel facing each other; a sealant disposed between the first display panel and the second display panel to define a sealant region and couple the first display panel to the second display panel; a blocking member disposed between the first display panel and the second display panel and neighboring the sealant; and a liquid crystal interposed between the first display panel and the second display panel, and disposed in the sealant region. The blocking member includes silicone formed from a silane derivative having at least one butyrate.

The silane derivative may have Chemical Formula 1:

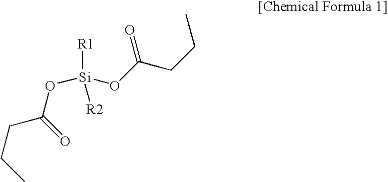

Wherein R1 and R2 may be same as or different from each other, and are selected from an alkyl group having 1 to 5 carbons.

The first display panel may include a plurality of gate lines extending parallel to each other according to a first direction, and a plurality of data lines extending parallel to each other and intersecting the gate lines, and the blocking member may include at least one of a first blocking member overlapping the gate lines and a second blocking member overlapping the data lines.

At least one of R1 and R2 of an alkyl group of Chemical Formula 1 may be combined with at least one functional group selected from a group consisting of an amide group, an ester group, an ether group, a sulfide group, a sulfoxide group, a hydroxy group, an imide group, an aza group, an amine group, an azo group, an aldehyde group, a carboxylic acid group, an anhydride group, a halide group, and a urea group.

The blocking member may be formed outside the sealant region.

A manufacturing method of a liquid crystal display according to an exemplary embodiment of the present invention includes: forming a first display panel including a plurality of signal lines, a thin film transistor connected to the signal lines, and a pixel electrode connected to the thin film transistor; forming a second display panel including a common electrode, forming a liquid crystal layer between the first display panel and the second display panel; coupling the first display panel to the second display panel using a sealant; and forming a blocking member between the first display panel and the second display panel along an edge of the second display panel, wherein the blocking member includes a silicone formed from silane derivatives having at least one butyrate.

The silane derivative may have Chemical Formula 1:

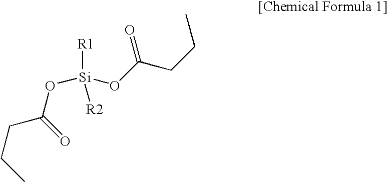

wherein R1 and R2 may be same as or different from each other, and are selected from an alkyl group having 1 to 5 carbons.

The blocking member may be formed outside a sealant region defined by the sealant.

The moisture may be prevented from flowing inside the liquid crystal display such that the corrosion of the gate lines and the data lines may be prevented, accordingly it is prevented that the short of the gate line or the data line is generated or the connection with the external circuit is deteriorated thereby reducing the deterioration of the liquid crystal display.

### BRIEF DESCRIPTION OF THE DRAWINGS

FIG. 1 is a perspective view of a liquid crystal display according to an exemplary embodiment of the present invention.

FIG. 2 is a layout view showing one pixel in the liquid crystal display of FIG. 1.

FIG. 3 is a cross-sectional view of the liquid crystal display shown in FIG. 2 taken along the line III-III.

FIG. 4 is a cross-sectional view showing the portion of the liquid crystal display shown in FIG. 1.

FIG. 5A is a photograph showing the effect for preventing the moisture when using a silicone formed from dimethyl silane dibutyrate according to an exemplary embodiment of the present invention.

FIG. 5B is a photograph showing the penetration of moisture inside a display panel when using a silicone formed from dimethyl silane diacetate as a comparative example.

### DETAILED DESCRIPTION OF THE EMBODIMENTS

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

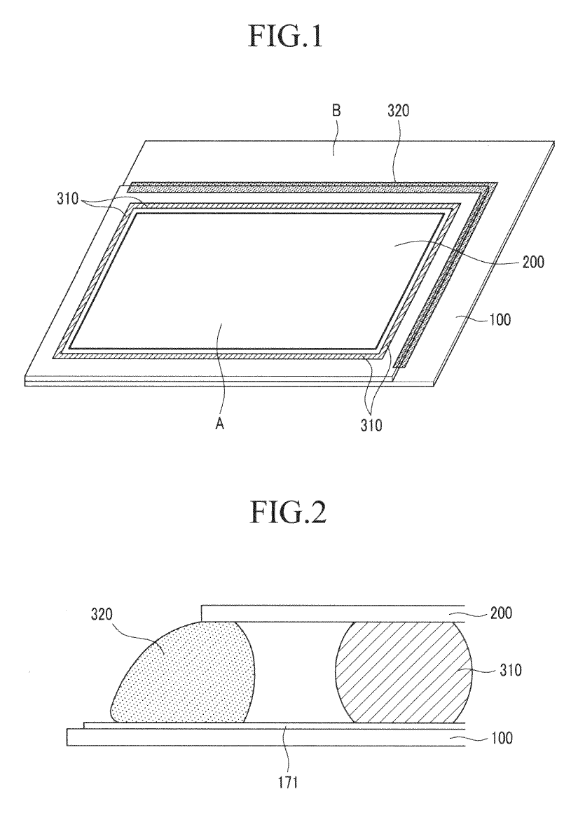

Now, a liquid crystal display according to an exemplary embodiment of the present invention will be described with reference to FIG. 1 to FIG. 4.

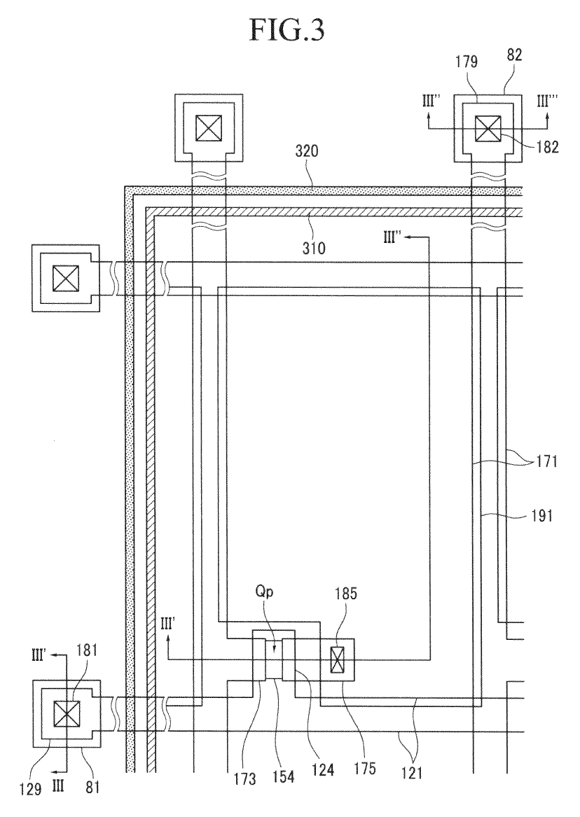

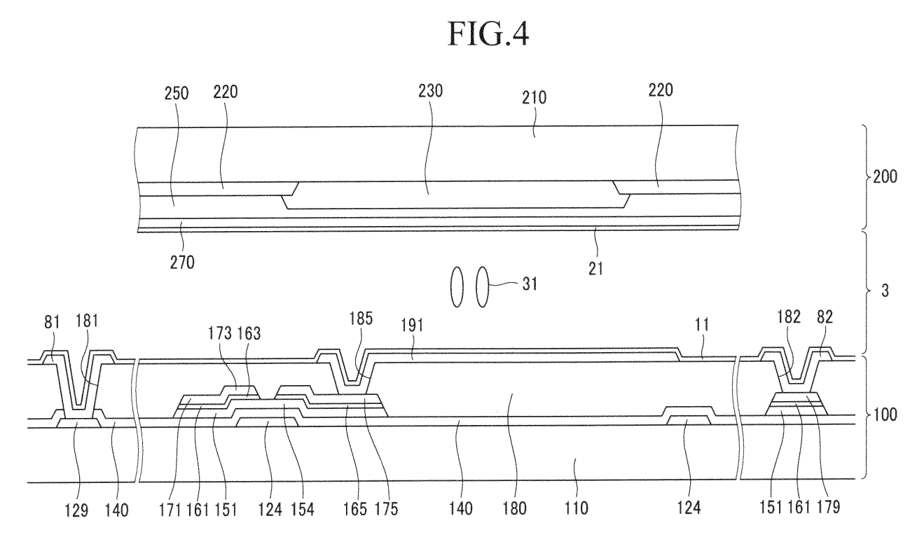

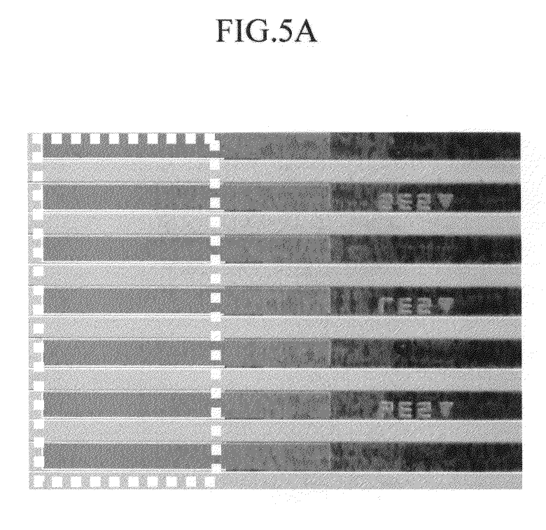

FIG. 1 is a perspective view of a liquid crystal display according to an exemplary embodiment of the present invention, FIG. 2 is a layout view showing one pixel in the liquid crystal display of FIG. 1, FIG. 3 is a cross-sectional view of the liquid crystal display shown in FIG. 2 taken along the line III-III, and FIG. 4 is a cross-sectional view showing the portion of the liquid crystal display shown in FIG. 1.

A liquid crystal display according to an exemplary embodiment of the present invention includes a thin film transistor array panel 100, a common electrode panel 200, and a liquid crystal layer 3 interposed between the two display panels 100 and 200.

Also, the liquid crystal display includes a display area A for displaying images and a pad region B that is connected to an external driving circuit.

First, the thin film transistor array panel 100 will be described.

A plurality of gate lines 121 transmitting gate signals are formed on an insulation substrate 110. Each gate line 121 includes a plurality of gate electrodes 124 extending upward and an end portion 129 that is wider than the rest of the gate line 121 for connection to an external circuit.

A gate insulating layer 140 is formed on the gate lines 121, and a plurality of semiconductor stripes 151 preferably made of amorphous or crystallized silicon are formed in a longitudinal direction on the gate insulating layer 140. The semiconductor stripes 151 include a plurality of protrusions 154 protruding toward the gate electrodes 124.

A plurality of ohmic contact stripes 161 and a plurality of ohmic contact islands 165 preferably made of n+ hydrogenated amorphous silicon heavily doped with an n-type impurity such as phosphors, or made of silicide, are formed on the semiconductor stripes 151. The ohmic contact stripes 161 include a plurality of protrusions 163 protruding toward the protrusions 154 of the semiconductor stripes 151, and a protrusion 163 and an ohmic contact island 165 are disposed as a pair on a protrusion 154 of a semiconductor stripes 151.

A plurality of data lines 171 and a plurality of drain electrodes 175 are formed on the ohmic contact stripes 161, the ohmic contact islands 165, and the gate insulating layer 140.

The data lines 171 extend in the longitudinal direction, thereby intersecting the gate lines 121, and transmit data voltages. Each data line 171 includes a plurality of source electrodes 173 extending toward the drain electrodes 175, and the source electrodes 173 and the drain electrodes 175 are opposite to each other as pairs on the gate electrodes 124.

A gate electrode 124, a source electrode 173, and a drain electrode 175 form a thin film transistor (TFT) along with a semiconductor stripe 151, and the channel of the thin film transistor is formed in the protrusion 154 of the semiconductor stripe 151 between the source electrode 173 and the drain electrode 175.

The semiconductor stripes 151, except for the channel regions between the source electrodes 173 and the drain electrodes 175, have substantially the same planar shape as the data lines 171 and the drain electrodes 175.

The ohmic contact stripes 161 are disposed between the semiconductor stripes 151 and the data lines 171, and have substantially the same planar shape as the data lines 171. The ohmic contact islands 165 are disposed between the semiconductor stripes 151 and the drain electrodes 175, and have substantially the same planar shape as the drain electrodes 175.

A passivation layer 180 is formed on the data lines 171 and the drain electrodes 175. The passivation layer 180 may be made of an inorganic insulating material such as silicon nitride or silicon oxide, or an organic insulating material such as acryl-based compound.

The passivation layer 180 has a plurality of contact holes 182 and 185 respectively exposing end portions 179 of the data lines 171 and the drain electrodes 175, and the passivation layer 180 and the gate insulating layer 140 have contact holes 181 exposing the end portions 129 of the gate line 121.

A plurality of pixel electrodes 191 and a plurality of contact assistants 81 and 82 are formed on the passivation layer 180.

The pixel electrodes 191 are physically and electrically connected to the drain electrodes 175 through the contact holes 185, and receive the data voltages from the drain electrodes 175.

The contact assistants 81 and 82 are respectively connected to the end portions 129 and 179 of the gate lines 121 and the data lines 179 through the contact holes 181 and 182. The contact assistants 81 and 82 help the end portions 179 and 129 of the data lines 171 and gate lines 121 adhere to outside components, and at the same time protects the end portions 129, 179.

Next, the common electrode panel 200 will be described.

A light blocking member 220 is formed on an insulating substrate 210 of the common electrode panel 200. The light blocking member 220 is referred to as a black matrix, and it prevents light leakage.

The light blocking member 220 has a plurality of aperture regions facing the pixel electrodes 191 and having almost the same shape as the pixel electrodes 191. The light blocking member 220 may have a portion corresponding to the gate lines 121 and the data lines 171 and a portion corresponding to the thin film transistor.

A plurality of color filters 230 are formed on the substrate 210. The color filters 230 are placed substantially within the aperture regions enclosed by the light blocking member 220. The color filters 230 may extend substantially in the longitudinal direction along the pixel electrodes 191. Each color filter 230 may represent one of three primary colors, such as red, green, and blue.

An overcoat 250 and a common electrode 270 are formed on the color filters 230.

Alignment layers 11 and 21 are formed on insides of the thin film transistor array panel 100 and the common electrode panel 200, respectively. The alignment layers 11 and 21 are formed on the display area A, and may be made of an insulating material such as polyimide.

The display panels 100 and 200 are adhered to each other and fixed by a sealant 310. The sealant 310 is formed along the circumference of the display area A, and defines a “sealant region” of a predetermined outline when seen in top view. The sealant region may be, but does not have to be, a completely dosed region. The sealant 310 has substantially the same height as the cell gap, and may be made of a heat-hardening or light-hardening material such as an acryl-based resin, an epoxy-based resin, an acryl-epoxy resin, and a phenol resin.

A blocking member 320 is formed near the sealant region to neighbor the sealant 310. For example, the blocking member 320 may be formed around the sealant region. The member 320 is coupled to the thin film transistor array panel 100 and the common electrode panel 200. The blocking member 320 is positioned at the boundary between the display area A and the pad region B. Accordingly, the blocking member 320 may overlap portions of the gate lines 121 and/or the data lines 171 extending from the display area A.

The blocking member 320 may be made of a silicone-based material such as polysiloxane, and the silicone may be expressed by Chemical Formula 2:

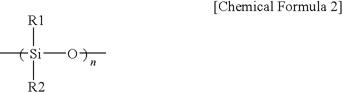

Here, R1 and R2 may be an alkyl group with 1 to 5 carbons, or the alkyl group may be combined with at least one functional group selected from an amide group, an ester group, an ether group, a sulfide group, a sulfoxide group, a hydroxy group, an imide group, an aza group, an amine group, an azo group, an aldehyde group, a carboxylic acid group, an anhydride group, a halide, and a urea group.

The silicone may be formed from silane derivatives having a butyrate.

The silane derivative having the butyrate group may be expressed by Chemical Formula 1, for example.

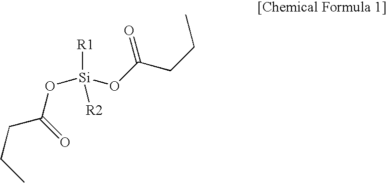

As shown in Chemical Formula 1, the silane derivative is a structure in which the butyryl group is coupled to the silicon as a center atom.

When the silane derivative of Chemical Formula 1 comes in contact with water (e.g., moisture in the air), the butyryl group separates off as a leaving group. The following chemical reaction formulas are examples of the cases in which R1 and R2 are each a methyl group.

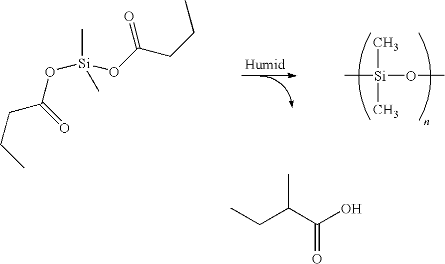

This butyryl group is a leaving group having a comparatively large size such that it may easily separate, and accordingly by-products may be reduced. The butyryl acid generated as the by-product has comparatively low solubility of less than about 35 wt % to water such that it may prevent the humidity in the air from flowing into the inner portion of the display panels 100 and 200. Also, when unhardened silane derivative remains, the silane derivative having the butyryl group as in Chemical Formula 1 has a large molecule size such that it is difficult for the silane derivative to diffuse to the inner portion of the display panels, and thereby remnants inside the display panels 100 and 200 may be reduced.

This may be compared with the case in which the blocking member 320 is formed from dimethyl silane diacetate having an acetate group or dimethyl silane dichloride having chlorine ions (Cl−).

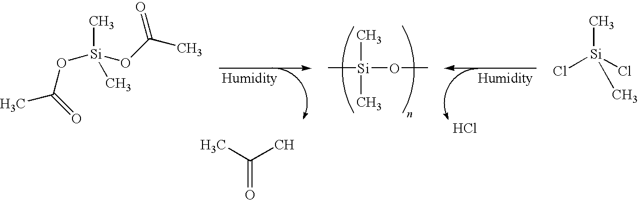

As shown in the above chemical reaction formula, when the dimethyl silane diacetate reacts with the humidity, polydimethylsiloxane is generated and acetic acid remains as a by-product. Also, when the dimethyl silane dichloride reacts with humidity, polydimethylsiloxane is generated and hydrochloric acid (HCl) remains as a by-product.

In this case, the acetic acid as a by-product has high acidity such that it may itself corrode a metal, and the unhardened dimethyl silane diacetate has a small molecule size such that it may be diffused into the inner part of the display panels 100 and 200 along with water molecules. Further, the hydrochloric acid (HCl) as a by-product has very high acidity such that it may itself corrode a metal, and it has virulence such that the product and the process may be deteriorated.

According to an exemplary embodiment of the present invention, as above-described, the silicone formed from the silane derivative having the butyryl group has a high reaction speed with humidity and the speed with which it is diffused inside the display panel is slow. Hence, the silicone may effectively prevent the moisture from flowing into the display panel.

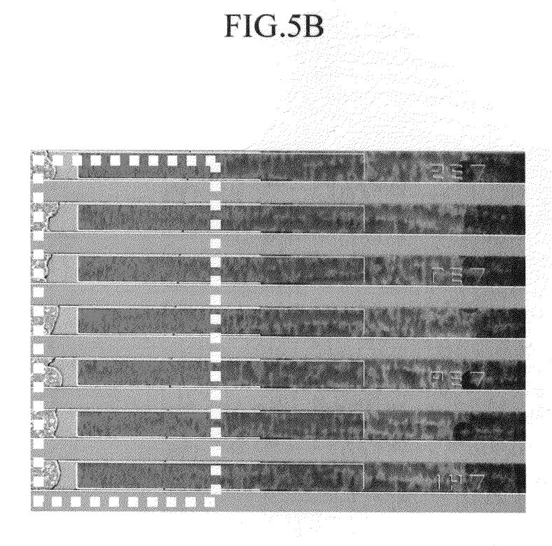

FIG. 5A and FIG. 5B show these effects.

FIG. 5A is a photograph showing the effect of preventing infiltration of the moisture when using a silicone formed from dimethyl silane dibutyrate according to an exemplary embodiment of the present invention, and FIG. 5B is a photograph showing the penetration of the moisture inside a display panel when using a silicone formed from dimethyl silane diacetate as a comparative example.

Referring to FIG. 5A, the silicone formed from the dimethyl silane dibutyrate effectively prevents the external moisture and prevents corrosion of the data line. However, in the example of FIG. 5B, the blocking member failed to effectively prevent moisture's infiltration of the device and the moisture remains at the end portion of the data line. As a result, the moisture generates corrosion of the data line and causes signal deterioration.

In the present exemplary embodiment, two silane derivatives having the butyryl group are described. However this is not a limitation of the invention and at least one butyryl group may be included in the silane derivative.

The liquid crystal layer 3 including a plurality of liquid crystal molecules 31 is interposed in the region defined by the sealant 310. The liquid crystal molecules 31 have negative or positive dielectric anisotropy, and liquid crystal molecules 310 of the liquid crystal layer 3 are aligned such that their longer axes are substantially perpendicular or parallel to the surfaces of the two display panels 100 and 200 in a state in which no electric field is applied, and are realigned in a state in which an electric field is applied between the common electrode 270 and the pixel electrodes 191.

Next, a manufacturing method of the liquid crystal display shown in FIG. 1 to FIG. 4 will be described.

First, a manufacturing method of the thin film transistor array panel 100 will be described.

A plurality of gate lines 121 including a plurality of gate electrodes 124 and end portions 129 are formed on an insulation substrate 110, and a gate insulating layer 140 is formed on the whole surface of the substrate including the gate lines 121.

Next, a semiconductor layer (not shown), an ohmic contact layer (not shown), and a data conductive layer (not shown) are sequentially deposited on the gate insulating layer 140, and a photoresist pattern (not shown) having different thicknesses depending on positions is formed.

Then, the data conductive layer, the ohmic contact layer, and the semiconductor layer are etched by using the photoresist pattern as a mask, and the data conductive layer then separately etched to form a plurality of data lines 171 including a plurality of source electrodes 173 and a plurality of drain electrodes 175. Subsequently, the exposed ohmic contact layer between the source electrodes 173 and the drain electrodes 175 is removed to form a plurality of ohmic contact stripes 161 including a plurality of protrusions 163, and a plurality of ohmic contact islands 165.

A passivation layer 180 is then deposited on the data lines 171 and the drain electrodes 175, and is patterned to form a plurality of contact holes 181, 182, and 185 along with the gate insulating layer 140.

Next, a plurality of pixel electrodes 191 and a plurality of contact assistants 81 and 82 are formed on the passivation layer 180, and an alignment layer 11 is coated thereon.

To form a common electrode panel 200, light blocking members 220 are formed on an insulation substrate 210, and a plurality of color filters 230 are formed thereon. A common electrode 270 is then formed on the light blocking member 220 and the color filters 230, and an alignment layer 21 is formed thereon.

Next, a sealant 310 is coated on one of the thin film transistor array panel 100 and the common electrode panel 200. The sealant 310 is coated to surround the display area A by using a dispenser (not shown). Here, the height of the sealant 310 may be equal to or more than the cell gap under consideration of the degree of pressure of two the panels 100 and 200.

Next, a liquid crystal 3 is dripped on one of the thin film transistor array panel 100 and the common electrode panel 200 on which the sealant 310 is coated.

The thin film transistor array panel 100 and the common electrode panel 200 are then assembled. It is preferable that the assembly process is executed in vacuum.

Next, the sealant 310 between the thin film transistor array panel 100 and the common electrode panel 200 is hardened by UV. A thermal hardening process may be used instead of or in addition to the UV hardening.

A blocking member 320 is then formed outside the sealant 310 between the thin film transistor array panel 100 and the common electrode panel 200. The blocking member 320 may also be coated according to the edge of the common electrode panel 200 by using a dispenser (not shown).

The blocking member 320 may be made from the silane derivative as above-described, and the silane derivative is allowed to slowly react with moisture in the air or polymerize by UV irradiation.

While this invention has been described in connection with what is presently considered to be practical exemplary embodiments, it will be apparent to those skilled in the art that various modifications and changes may be made thereto without departing from the scope and spirit of the invention. For example, although the specific examples are provided in the context of preventing moisture from reaching portions of the signal lines that extend to areas outside the sealant region, this is not a limitation of the invention. Likewise, the particular position of the blocking member shown herein is not a limitation of the invention. Accordingly, it is to be understood that the invention is not limited to the disclosed embodiments, but, on the contrary, is intended to cover various modifications and equivalent arrangements included within the spirit and scope of the appended claims.

What is claimed is:

1. A liquid crystal display comprising:
a first display panel and a second display panel facing each other;
a sealant disposed between the first display panel and the second display panel to define a sealant region and couple the first display panel to the second display panel;
a blocking member disposed between the first display panel and the second display panel and neighboring the sealant, wherein the blocking member includes silicone formed from a silane derivative having at least one butyrate; and
a liquid crystal layer interposed between the first display panel and the second display panel and disposed in the sealant region

2. The liquid crystal display of claim 1, wherein
the silane derivative has Chemical Formula 1: 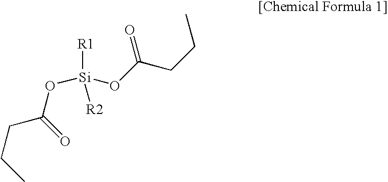
wherein R1 and R2 are same as or different from each other, and are selected from an alkyl group with 1 to 5 carbons.

3. The liquid crystal display of claim 2, wherein
the first display panel includes
a plurality of gate lines extending parallel to each other according to a first direction, and
a plurality of data lines extending parallel to each other and intersecting the gate lines, and
the blocking member includes at least one of
a first blocking member overlapping the gate lines, and
a second blocking member overlapping the data lines.

4. The liquid crystal display of claim 2, wherein
at least one of R1 and R2 of an alkyl group of Chemical Formula 1 is combined with at least one functional group selected from
a group consisting of an amide group, an ester group, an ether group, a sulfide group, a sulfoxide group, a hydroxy group, an imide group, an aza group, an amine group, an azo group, an aldehyde group, a carboxylic acid group, an anhydride group, a halide group, and a urea group.

5. The liquid crystal display of claim 1, wherein the blocking member is formed outside the sealant region.

6. A method for manufacturing a liquid crystal display comprising:
forming a first display panel including a plurality of signal lines, a thin film transistor connected to the signal lines, and a pixel electrode connected to the thin film transistor;
forming a second display panel including a common electrode;
forming a liquid crystal layer between the first display panel and the second display panel;
coupling the first display panel to the second display panel using a sealant; and
forming a blocking member between the first display panel and the second display panel along an edge of the second display panel, wherein the blocking member includes a silicone formed from silane derivatives having at least one butyrate.

7. The method of claim 6, wherein
the silane derivative has Chemical Formula 1: 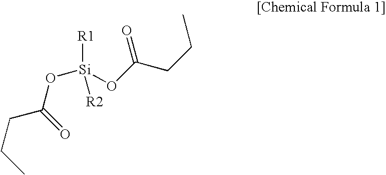
wherein R1 and R2 are same as or different from each other, and are selected from an alkyl group with 1 to 5 carbons.

8. The method of claim 6, wherein forming the blocking member comprises forming the blocking member outside a sealant region defined by the sealant.
